(19) United States
(12) Patent Application Publication
(10) Pub. No.: US 2026/0273457 A1
(43) Pub. Date: Sep. 17, 2026

(54) CARBON DIOXIDE EXTRACTION USING DIFFUSION

(71) Applicant: INTERNATIONAL BUSINESS MACHINES CORPORATION, ARMONK, NY (US)

(72) Inventors: Theodore G. van Kessel, Millbrook, NY (US); Benjamin Hardy Wunsch, Mt. Kisco, NY (US)

(21) Appl. No.: 19/007,653

(22) Filed: Jan. 2, 2025

(51) Int. Cl. B01D 53/22

(52) U.S. Cl. CPC B01D 53/229; B01D 2053/222; B01D 2251/21; B01D 2257/504

(57) ABSTRACT

An apparatus for extracting carbon dioxide including a panel structure having a thermal gradient between a first side and a second side, and a porous wicking material soaked in an aqueous amine solution disposed within the panel structure between the first side and the second side is provided. The porous wicking material is configured to absorb a low concentration of carbon dioxide gas at the first side and desorb a high concentration of carbon dioxide gas at the second side. An associated method is also provided.

### BACKGROUND

The following relates to embodiments for extracting carbon dioxide from gas, and more specifically to a panel structure and method thereof. Carbon capture and sequestration is a central focus of efforts to reduce a rate of climate change due to greenhouse gas accumulation in the atmosphere.

### SUMMARY

An aspect relates to an apparatus for extracting carbon dioxide, comprising: a panel structure having a thermal gradient between a first side and a second side, and a porous wicking material soaked in an aqueous amine solution disposed within the panel structure between the first side and the second side, the porous wicking material configured to absorb a low concentration of carbon dioxide gas at the first side and desorb a high concentration of carbon dioxide gas at the second side.

Another aspect relates to an apparatus for extracting carbon dioxide from, comprising: a panel structure having a first side and a second side that is in thermal contact with a solar radiation panel, wherein solar radiation absorption of the solar radiation panel heats the second side to cause a thermal gradient between the first side and the second side, an inlet disposed on the panel structure, the inlet configured to receive air having a low concentration of carbon dioxide gas, a porous wicking material soaked in an aqueous amine solution disposed within the panel structure between the first side and the second side, the porous wicking material configured to absorb the low concentration of carbon dioxide gas at the first side and desorb a high concentration of carbon dioxide gas at the second side, and an outlet for extracting the high concentration of carbon dioxide gas from the panel structure.

Another aspect relates to a method for capturing and concentrating carbon dioxide from a gas, the method comprising: creating a thermal gradient across a porous wicking material soaked with an aqueous amine solution encased within a panel structure having a cool side and an opposing hot side, introducing a low concentration carbon dioxide gas to the aqueous amine solution at a cool side of the panel structure, and capturing and extracting a high concentration of carbon dioxide gas at the hot side of the panel structure.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a side cross-section view of a panel structure, in accordance with embodiments of the present invention;

FIG. 2 depicts a top view of the panel structure, in accordance with embodiments of the present invention;

FIG. 3 depicts a bottom view of the panel structure, in accordance with embodiments of the present invention;

FIG. 4 depicts a section view along line A-A in FIG. 1, in accordance with embodiments of the present invention;

FIG. 5 depicts a section view along line C-C in FIG. 4, in accordance with embodiments of the present invention;

FIG. 6 depicts a section view along line D-D in FIG. 4, in accordance with embodiments of the present invention;

FIG. 7 depicts a section view along line B-B in FIG. 2, in accordance with embodiments of the present invention;

FIG. 8 depicts multiple gradients of the panel structure and corresponding flow within panel structure, in accordance with embodiments of the present invention;

FIG. 9 depicts a flow of gas having a low concentration carbon dioxide introduced into the panel structure at a first side of the panel structure, in accordance with embodiments of the present invention;

FIG. 10 depicts a flow of gas having a high concentration carbon dioxide at a second side of the panel structure, in accordance with embodiments of the present invention;

FIG. 11 depicts a diffusion process across the panel structure as a function of the gradients, in accordance with embodiments of the present invention;

FIG. 12 depicts an embodiment of the panel structure with flow moving components coupled to the panel structure, in accordance with embodiments of the present invention;

FIG. 13 depicts an embodiment of the panel structure with a heat sink on the first side of the panel structure and a heat source on the second side of the panel structure, in accordance with embodiments of the present invention;

FIG. 14 depicts an embodiment of a solar panel integrated with the panel structure, in accordance with embodiments of the present invention;

FIG. 15 depicts an embodiment of the panel structure enclosed in by a glass layer, in accordance with embodiments of the present invention; and

FIG. 16 depicts a flow chart of a method for carbon capture, in accordance with embodiments of the present invention.

### DETAILED DESCRIPTION

A detailed description of the hereinafter described embodiments of the disclosed apparatus and method are presented herein by way of exemplification and not limitation with reference to the Figures. Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure.

As a preface to the detailed description, it should be noted that, as used in this specification and the appended claims, the singular forms “a”, “an” and “the” include plural referents, unless the context clearly dictates otherwise.

In brief overview, carbon capture and extraction relies on the ability to separate carbon dioxide (CO₂) gas from other gasses at typically low concentrations (e.g. 15% to 30%) and purify the gas (e.g. to 90% or better). In the case of atmospheric CO₂, the concentration is very low (e.g. 0.04% by volume). Conventional methods of carbon capture require significant amounts of energy to drive a temperature swing to heat and cool an aqueous amine solution to absorb CO₂ from gas streams at low temperature and concentration and then release CO₂ at high concentration suitable for subsequent liquefaction or downstream use. These conventional methods use separate vessels for the absorption and desorption of CO₂, respectively, which are heated and cooled by external components (e.g. heat exchangers). Further, industrial pumps are required to pump the contents of one vessel to another vessel adding to both the energy required to operate the carbon capture process and the footprint of the overall system.

Embodiments of the present invention utilize amine solvents and diffusion to capture and purify CO2 in a single monolithic system that does not require heating and cooling water in bulk and avoids the use of separate heat exchangers and pumps. In an exemplary embodiment, the present invention includes a narrow slab of mechanically stiff porous material that wicks a solution of aqueous amine across which a thermal gradient is imposed by exposing one side to a heat source (e.g. solar irradiation) and the opposite side to a heat sink (e.g. air convection cooling). A low concentration CO2 gas stream is flowed through channels on the cold side of the porous slab where CO2 is absorbed by direct contact with the amine solution creating carbamates and/or carbonates in solution. Dissolved carbamate and/or carbonates diffuse across the thermal gradient to the hot side where the CO2 is desorbed via the reverse reaction (reforming the amine) at the higher temperatures and escapes directly through channels on the hot side of the slab. The driving force for this diffusion is the chemical concentration gradient. Accordingly, embodiments of the present invention uniquely utilize a monolithic structure, diffusion, chemical concentration gradients, and a thermal gradient to concentrate carbon dioxide from air or flue gas, thereby eliminating the need for circulation pumps and counterflow heat exchangers to drive the thermal swing necessary for the carbon capture process. As will be explained in greater detail infra, embodiments of the present invention can use solar radiation to drive the thermal swing carbon capture process.

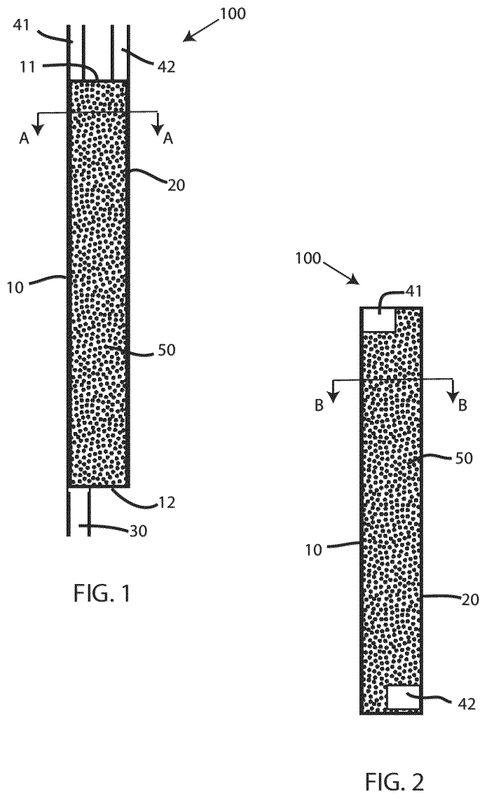

Referring now to the drawings, FIG. 1 a side cross-section view of a panel structure 100, in accordance with embodiments of the present invention. The panel structure 100 is an apparatus for extracting carbon dioxide. The panel structure 100 includes has a thermal gradient between a first side 10 (e.g. cool side) and a second side 20 (e.g. hot side). A porous wicking material 50 soaked in an aqueous amine solution is disposed within the panel structure 100 between the first side 10 and the second side 20. The porous wicking material 50 is configured to absorb a low concentration of carbon dioxide gas at the first side 10 and desorb a high concentration of carbon dioxide gas at the second side 20. The panel structure 100 includes an inlet 30 for receiving low concentration carbon dioxide gas into the panel structure 100. The source of the carbon dioxide gas may be ambient air. The source of carbon dioxide gas could also be flue gas or exhaust gas released into the atmosphere after combustion. In some embodiments, the flue gas could be delivered to the inlet 30 (e.g. via piping) from an exhaust of one or more machines. The inlet 30 is located on the bottom side 12 of the panel structure 100 at or otherwise proximate the first side 10 of the panel structure 100.

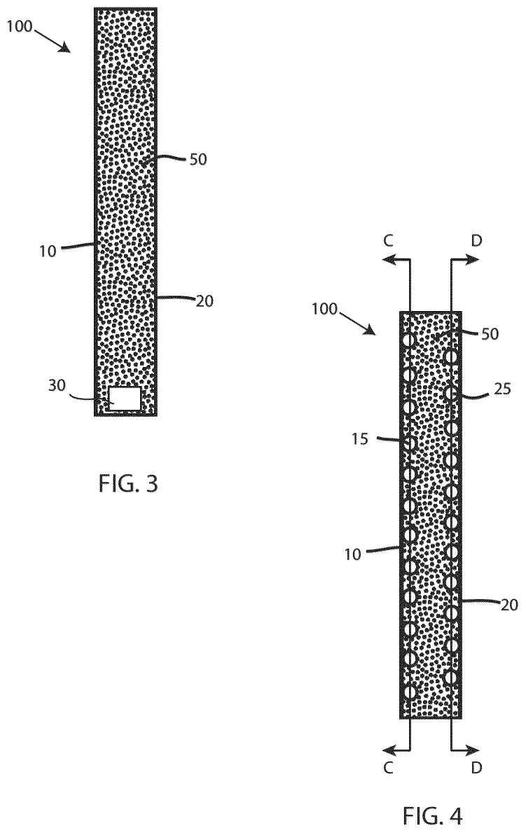

An outlet 42 for extracting a high concentration of carbon dioxide gas out of the panel structure 100 is located on the top side 11 of the panel structure 100 at or otherwise proximate the second side 20 of the panel structure 100. Also located on the top side 11 at or other proximate the first side 10 of the panel structure is another outlet 41. Outlet 41 allows the escape of depleted low concentration carbon dioxide gas from the panel structure, along with other gases that did not diffuse to the second side 20. The gases exiting outlet 41 may be recycled back into the panel structure 100 via a recycling loop to reintroduction into the panel structure 100. Moisture that evaporates from either a lean side or a rich side of the apparatus may escape through the outlets 41 and 42, which can be replenished over time within the panel structure. The outlets 41, 42 can be positioned on the top side 11 at any point along the first side 10 and second side 20, respectively. FIG. 1 shows outlets 41, 42 positioned at a same position horizontally across the top side 11, with outlet 41 at the first side 10 and the outlet 42 at the second side 20. FIG. 2 depicts a top view of the panel structure 100, in accordance with embodiments of the present invention. As shown in FIG. 2, the outlets 41 and 42 are disposed on opposite sides of the top end 11 of the panel structure 100, with the outlet 41 at the first side 10 and the outlet 42 at the second side 20. Similar to the outlets 41, 42, the location of the outlet 30 can vary by application and/or structural configuration of the panel structure 100. For instance, the outlet 30 can be positioned on the bottom side 12 at any point along the first side 10. FIG. 1 shows the inlet 30 positioned at a same position horizontally across the panel structure 100 as outlet 41 and outlet 42. FIG. 3 depicts a bottom view of the panel structure 100, in accordance with embodiments of the present invention. As shown in FIG. 3, the outlet 30 is disposed towards an edge of the panel structure on the bottom side 12 at the first side 10 of the panel structure 100.

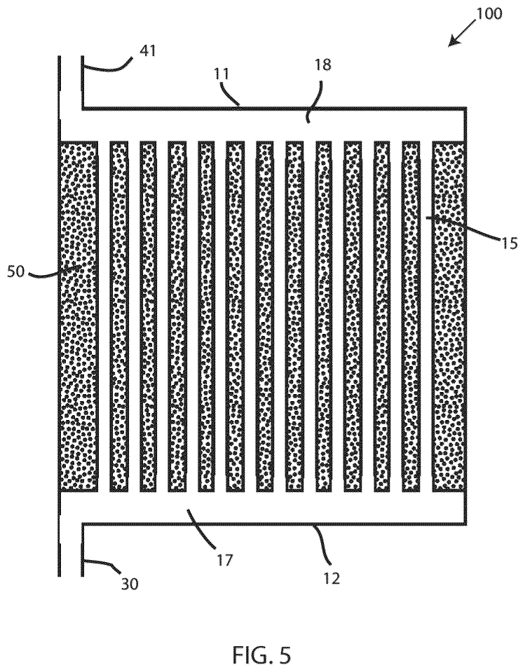

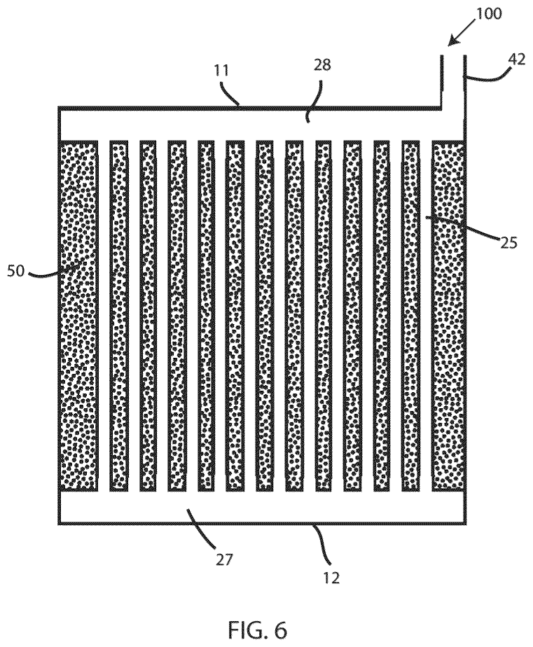

The panel structure 100 further includes a first plurality of channels 15 disposed within the panel structure 100 at or proximate the first side 10, and a second plurality of channels 25 disposed within the panel structure 100 at or proximate the second side 20. FIG. 4 depicts a section view of the panel structure 100 along line A-A in FIG. 1, in accordance with embodiments of the present invention. As shown in FIG. 4, the first plurality of channels 15 and the second plurality of channels 25 are in contact with the porous wicking material 50. In an exemplary embodiment, the channels 15, 25 are a void, groove, passageway, and the like formed into porous wicking material 50. In another exemplary embodiment, the channels 15, 25 are porous membranes, piping, conduit, or tubing inserted into the panel structure 100 between the inner surface of the first side 10/second side 20 and the porous wicking material 50. The channels 15, 25 extend vertically within the panel structure 100 and allow gas to travel therethrough from the bottom side 12 to the top side 11 of the panel structure 100. The channels 15, 25 allow intimate contact between the gasses flowing in the channels 15. 25 and the amine solution in the wicking material such that CO2 exchange is possible at the liquid gas interface. FIG. 5 depicts a section view of the panel structure 100 along line C-C in FIG. 4, showing the first plurality of channels 15, in accordance with embodiments of the present invention. As shown in FIG. 5, the panel structure 100 includes an inlet gas manifold 17 in fluid communication with the inlet 30 and the first plurality of channel 15. The inlet gas manifold 17 is positioned at the bottom end 12 at the first side 10 of the panel structure 100 and connects the inlet 30 to the first plurality of channels 15 along a width of the panel structure 100. A return manifold 18 is located at the top end 11 at the first side 10 of the panel structure 100 to connect the outlet 41 to the first plurality of channels 15. The return manifold 18 receives depleted low concentration carbon dioxide from the first plurality of channels 15 which exits the panel structure though outlet 41. In some embodiments, the panel structure 100 will be wide rather than high. This is due to the fact that the wicking structure is limited in height due to gravity and the surface tension of the fluid therein. The panel structure 100 may also be tilted with respect to the vertical to allow greater height to the structure.

FIG. 6 depicts a section view of the panel structure 100 along line D-D in FIG. 4, showing the second plurality of channels 25, in accordance with embodiments of the present invention. As shown in FIG. 6, the panel structure 100 includes an outlet gas manifold 28 in fluid communication with the outlet 42 and the second plurality of channel 25. The outlet gas manifold 28 is positioned at the top end 11 at the second side 20 of the panel structure 100 and connects the outlet 42 to the second plurality of channels 25 along a width of the panel structure 100. The outlet gas manifold 28 receives high concentration carbon dioxide that has desorbed from the porous wicking material 50 into the second plurality of channels 25 which then exits the panel structure though outlet 42. The panel structure 100 optionally include a lower outlet manifold 27 located at the bottom end 12 at the second side 20 of the panel structure 100 to further capture high concentration carbon dioxide gas and facilitate the flow toward the outlet 42.

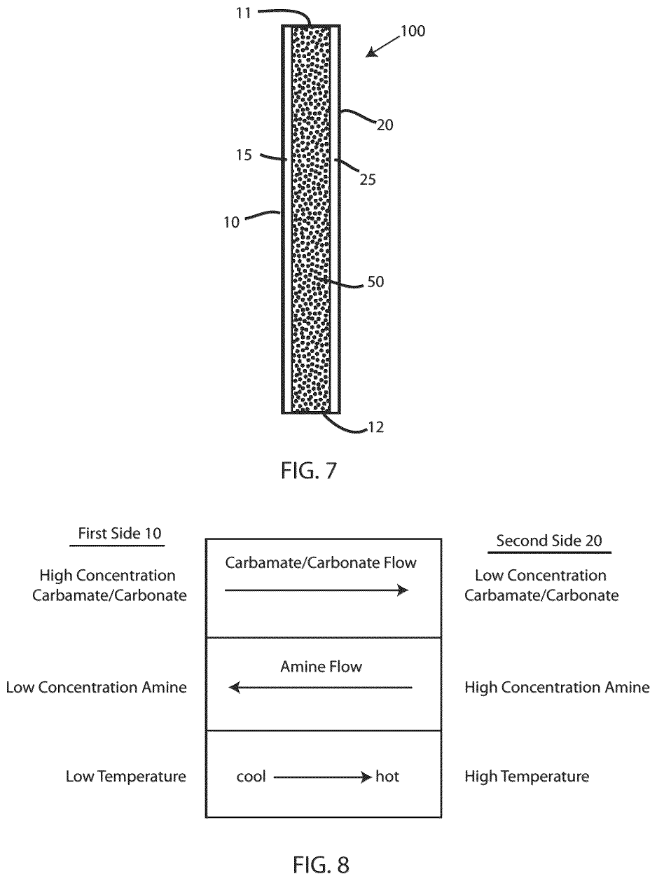

FIG. 7 depicts a section view of the panel structure 100 along line B-B in FIG. 2, in accordance with embodiments of the present invention. The section is through a channel of the first plurality of channels 15 and a channel of the second plurality of channels 25. As shown, the channels 15, 25 are separated by and in contact with the porous wicking material 50. Low concentration carbon dioxide gas within the first plurality of channels 15 reacts with the amine and diffuses across the porous wicking material 50 in the form of carbonate and or carbamate and desorbs and enters the second plurality of channels 25 as a high concentration of carbon dioxide gas as will be described in greater detail infra.

The porous wicking material 50 includes pores that allow gas to flow therethrough. Examples of the porous wicking material 50 include a rigid foam material, open cell foam material, ceramic materials, fibrous material, and the like. Some examples of foam wicking materials include but are not limited to: melamine foam, polyurethane foam, polyethylene foam, silicone foam, polyvinyl alcohol (pva) foam, cellulose foam and metallic foams of nickel and aluminum. Some examples of ceramic wicking materials include but are not limited to: porous alumina, porous zirconia, silica-based ceramics, porous cordierite, kaolinite-based ceramics, ceramic fiber materials, and porous ceramic tubes. Some examples of fibrous materials include but are not limited to nylon, acrylic, polyester, and polypropylene. The porous wicking material is soaked or saturated with an aqueous amine solution. In an exemplary embodiment, the aqueous amine solution is 30% by weight aqueous solution of monoethanolamine. However, hundreds of different amines and mixtures of amines can be used to soak the porous wicking material. The aqueous amine solution used to saturate the porous wicking material 50 is not limited to single component solutions and can include multicomponent solutions. Key parameters for selecting the aqueous amine solution include low volatility, low viscosity, high reaction rate, high molecular weight, and absorption capacity or carrier capacity. Low volatility amine solutions to resist evaporation. The selection of the specific amine solution can also affect the dimensions of the panel structure 100, including a thickness of the porous wicking material 50. In an exemplary embodiment, a thickness of the porous wicking material is 5 mm-10 mm. The distance between the first side 10 and the second side 20 should be narrow enough to have a thermal gradient between the two sides 10, 20.

Moreover, the aqueous amine solution of the porous wicking material 50 absorbs the carbon dioxide gas and reacts with the carbon dioxide to form dissolved carbamate and/or carbonate. In an exemplary embodiment, the aqueous amine solution of the porous wicking material 50 reacts with carbon dioxide to form carbamate and/or carbonate according to the following equation:

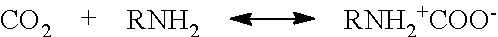

wherein R is a backbone of an amine.
   Aqueous amine solutions and mixtures react aggressively with dissolved carbon dioxide to form carbamate and/or carbonate (depending on the particular amine) at low temperatures and react in the reverse direction at higher temperatures evolving carbon dioxide.

Referring still to the drawings, FIG. 8 depicts the multiple gradients of the panel structure 100 and corresponding flow paths within the panel structure 100, in accordance with embodiments of the present invention. Chemical concentration gradients drive the reactants of the forward and the reverse direction across a thermal gradient where carbon dioxide is absorbed and desorbed. Diffusion of absorbed carbon dioxide gas across the porous wicking material 50 is a function of a thermal gradient (i.e. cool side to hot side), a first concentration gradient (i.e. concentration gradient of amine between the first side 10 and the second side 20), and a second concentration gradient (i.e. concentration gradient of carbamate or carbonate between the first side 10 and the second side 20).

The thermal gradient between the first side 10 and the second side 20 is created by cooling the first side 10 and heating the second side 20, and thus the first side 10 is referred to as the cool side (e. g 40°-60° C.) and the second side 20 is referred to as the hot side (e.g. 90°100° C. or more). The first side 10 can be cooled using a variety of methods. For instance, the first side 10 can be cooled using ambient air flowing across the surface of the first side 10. The first side 10 can be cooled convectively by air. The first side 10 can also be cooled using heat sinks, such as fins. The first side 10 can be cooled by flowing cold water, Peltier elements, heat pumps, etc. Other cooling methods requiring energy may be used. Likewise, the second side 20 can be heated using a variety of methods. For instance, the second side 20 can be heated using waste heat. Waste heat can come from solar panels attached to the second side 20 which heat up when exposed to solar radiation, or can come from the output of one or more operating machines (e.g. turbine). The second side 20 can also be heated directly by incident solar radiation contacting the second side 20; the second side 20 can be painted with a black paint or other coating with a high emissivity ratio (e.g. iron(III)oxide) suited for absorbing solar radiation thereby heating the second side 20 of the panel structure 100. Further, the second side 20 can be heated flowing hot water, Peltier elements, electrical resistance heaters, heat pumps, and the like.

The sides 10, 20 of the panel structure 100 can be comprised of a metallic material to promote good thermal conductivity. In an exemplary embodiment, the sides 10, 20 are made of aluminum. Other suitable metallic materials that can be used for the sides 10, 20 include copper, steel, and stainless steel. The sides 10, 20 are panels that are connected together with other panels to form an enclosure that is airtight, gastight, and watertight. A vapor barrier can be installed within the panel structure 100.

The concentration gradient of amine between the first side 10 and the second side 20 is defined by a low concentration of amine at the first side 10 and a high concentration of amine at the second side 20, causing carbonate and/or carbamate to flow/diffuse towards the second side 20. The concentration gradient of carbonate and/or carbamate between the first side 10 and the second side 20 is defined by a high concentration of carbonate and/or carbamate at the first side 10 and a low concentration of carbonate and/or carbamate at the second side 20, causing the amine to flow/diffuse towards the first side 10.

The carbon dioxide absorbed by the porous wicking material 50 at the first side 10 reacts with the aqueous amine solution at a low temperature to form carbamate and/or carbonate. As a result, there is a high concentration of carbonate and/or carbamate at the first side 10 as compared to the second side 20, and a low concentration of amine at the first side 10 because the amine has been converted to carbonate or carbamate. The carbamate and/or carbonate diffuses across the porous wicking material 50 to the second side 20 due to the concentration gradient between the sides 10, 20; the carbonate and/or carbamate wants to go where it can release the carbon dioxide at the hot side. At the second side 20, the carbamate and/or carbonate reacts with the aqueous amine solution at a temperature higher than the first side 10 to release carbon dioxide which is desorbed from the porous wicking material 50 and extracted from the panel structure 100. The carbonate and/or carbamate releases the carbon dioxide and is converted to an amine again. Thus, there is a higher concentration of amines at the second side 20. The amines flow/diffuse back toward the first side 10 due to the concentration gradient between the second side 20 (high concentration of amines) and the first side 10 (low concentration of amines) to recapture another carbon. The cycle continues due to the gradients.

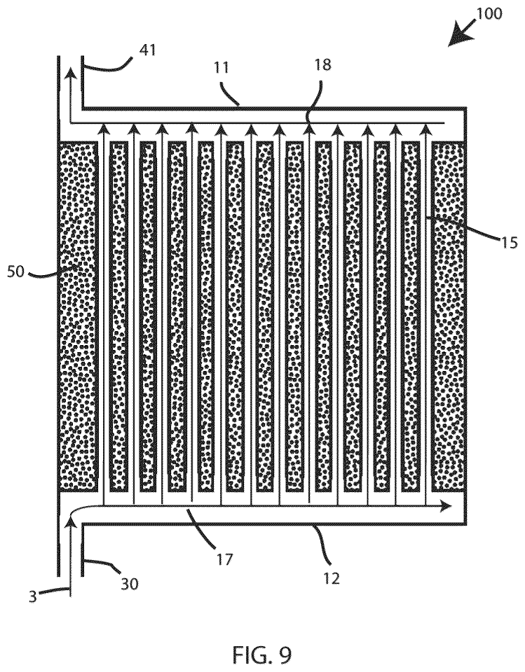

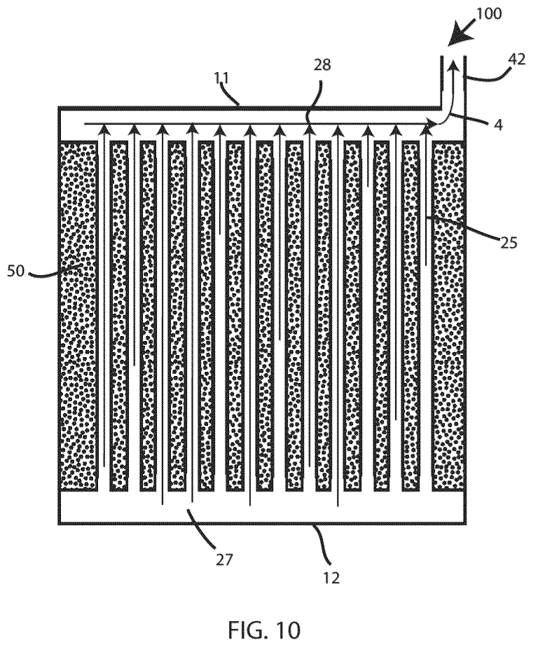

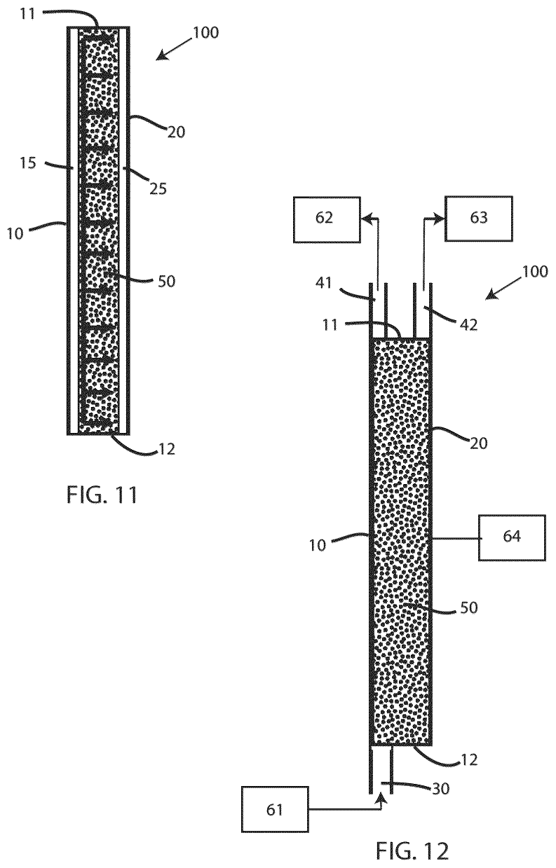

The flow of gas (e.g. air or flue gas stream) through the panel structure 100 will now be described with reference to FIGS. 9-11. FIG. 9 depicts a flow of gas 3 having a low concentration carbon dioxide introduced into the panel structure 100 at a first side 10 of the panel structure 100, in accordance with embodiments of the present invention. In practice, low concentration will typically be in a range of 0.04 % to ~30%. This is not restricted in that the amine will react with CO2 energetically a low temperature. The low concentration of carbon dioxide gas 3 is introduced within the panel structure 100 through the inlet 30 and flows through the first plurality of channels 15 via the inlet gas manifold 17 to contact the porous wicking material 50. A portion of the gas 3 may not react with the porous wicking material 50 and flow to the return manifold 18 which exits the panel structure though outlet 41. The gas 3 enters the first plurality of channels 15 and reacts with the amine in the porous wicking material 50 to form carbonates and/or carbamates at a low temperature, which diffuse across the porous wicking material 50 to the second plurality of channels 25, as shown in FIG. 11. The diffusion of the carbonates and/or carbamate from the first side 10 to the second side 20 occurs due to the concentration gradient (i.e. lower concentration of carbonate and/or carbamate at the second side 20). Because the temperature is higher at the second side 20, the carbamate and/or carbonate reacts at the higher temperature to release carbon dioxide which is desorbed from the porous wicking material 50 and enters the second plurality of channels 25, as shown in FIG. 10, which depicts a flow of gas 4 having a high concentration carbon dioxide at a second side 20 of the panel structure 100, in accordance with embodiments of the present invention. The concentration of CO2 at the high concentration side will be close to 100%. There will be some evaporation of water as well that must be made up. The gas 4 may be desorbed from the porous wicking material 50 at various heights within the panel structure 100, depicted in FIG. 10 by the flow of gas 4 starting at various locations within the second plurality of channels 25. The desorbed high concentration of carbon dioxide gas 4 enters the second plurality of channels 25 and flows through the second plurality of channels 25 to the outlet gas manifold 28 for exiting the panel structure 100 via the outlet 42.

Turning now to FIG. 12, which depicts an embodiment of the panel structure 100 with flow moving components 61, 62, 63 coupled to the panel structure 100, in accordance with embodiments of the present invention. To introduce a gas or flue gas stream into the panel structure 100, a flow moving component 61 is fluidically coupled to the inlet 30. The flow moving component 61 can be a fan, a pump, and the like that moves, pumps, or otherwise directs a flow of gas or flue gas into the inlet 30. In an exemplary embodiment, the flow moving component 61 draws in ambient air into the panel structure 100. In another exemplary embodiment, the flow moving component 61 draws in a flue gas into the panel structure 100. The flow moving component 61 is fluidically coupled to the inlet 30 via a conduit, a pipe, a tube, and the like. Alternatively, the flow moving component 61 is integrated with the inlet 30 or installed at the inlet 30 to draw air or flue gas directly into the inlet 30.

To extract the high concentration carbon dioxide gas released by the porous wicking material 50 into the second plurality of channels 25 and/or the outlet gas manifold 28, a flow moving component 63 is fluidically coupled to the outlet 42. The flow moving component 62 can be a fan, a pump, and the like that moves, pumps, sucks, or otherwise draws a flow of high concentration carbon dioxide gas from the panel structure 100 out through the outlet 42. The flow moving component 63 is fluidically coupled to the outlet 42 via a conduit, a pipe, a tube, and the like. Alternatively, the flow moving component 63 is integrated with the outlet 42 or installed at the outlet 42 to draw the high concentration carbon dioxide gas from the panel structure 100 directly at the outlet 42.

The flow moving component 62 can be a fan, a pump, and the like that moves, pumps, sucks, or otherwise draws a flow of depleted low concentration carbon dioxide gas from the panel structure 100 out through the outlet 41. The flow moving component 62 is fluidically coupled to the outlet 41 via a conduit, a pipe, a tube, and the like. Alternatively, the flow moving component 62 is integrated with the outlet 41 or installed at the outlet 41 to draw the depleted low concentration carbon dioxide gas from the panel structure 100 directly at the outlet 41. Fans, pumps etc. can be balanced and care can be taken to not introduce a pressure gradient across the porous material that exceeds a surface tension of the amine contained therein.

FIG. 12 also schematically depicts a heat source 64 coupled to the panel structure 100, in particular, to the second side 20 of the panel structure 100. The heat source 64 is in thermal contact with the second side 20 to heat the second side 20 of the panel structure 100. The heat source 64 can be solar radiation, a solar panel, waste heat, flowing hot water, Peltier elements, electrical resistance heaters, heat pumps, and the like. The heat source 64 can be physically attached to the panel structure 100, such as a solar panel or a heat exchanger, or the heat source 64 is only in thermal contact with the panel structure 100, such as solar radiation incident on the panel structure 100.

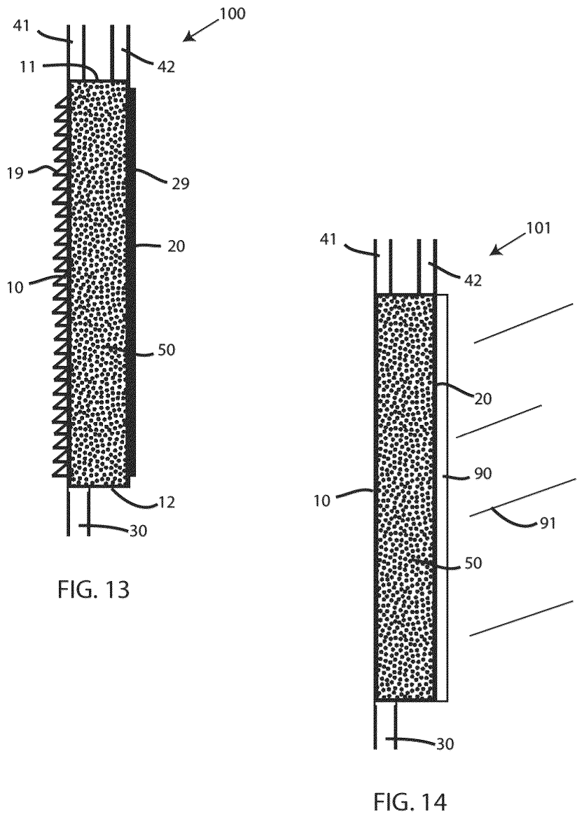

FIG. 13 depicts an embodiment of the panel structure 100 with a heat sink 19 on the first side 10 of the panel structure 100 and a heat source on the second side 20 of the panel structure 100, in accordance with embodiments of the present invention. In the illustrated embodiment, a heat sink 19 is attached to the first side 10 in the form of a plurality of fins. The heat sink 19 transfers heat from the first side 10 to the ambient air so that the first side 10 is cooled as compared to the second side 20. The heat source is a coating material 19 applied to the external surface of the second side 20 of the panel structure 100. The coating 19 can be black paint, thermal grease, oil, iron(III)oxide, or other coating that has a high emissivity ratio. In direct exposure to the sun, the coating 29 heats up and transfers the heat to the second side 20 based on the thermal contact between the coating 29 and the second side 20.

FIG. 14 depicts an embodiment of a solar panel 90 integrated with a panel structure 101, in accordance with embodiments of the present invention. The panel structure 101 shares the same features of the panel structure 100 except that it is integrated with a solar panel 90 that is designed to convert solar radiation 91 into electrical energy using photovoltaic cells. As the solar panel 90 absorbs the solar radiation 91, waste heat is generated that is transferred to the second side 20 of the panel structure 101. In this way, a solar panel 90 can be outfitted with the panel structure 101 such that the solar panel 90 both converts solar radiation 91 into electrical energy and powers carbon dioxide capture and extraction using the waste heat from the solar panel 90 to heat the second side 20 of the panel and drive a thermal swing inside the panel structure 101 without the need for heat sources requiring energy to drive the thermal swing (i.e. thermal gradient).

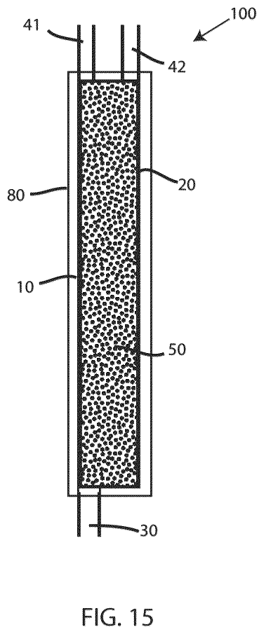

FIG. 15 depicts an embodiment of the panel structure 100 enclosed in by a glass layer 80, in accordance with embodiments of the present invention. The glass layer 80 can reduce thermal leakage. The glass layer 80 surrounding the panel structure 100 forms a glass enclosure enclosing the panel structure 100 with an air gap between the panel structure 100 and the glass layer 80, thereby reducing thermal leakage from the panel structure 100. A gas barrier may be introduced within the air gap.

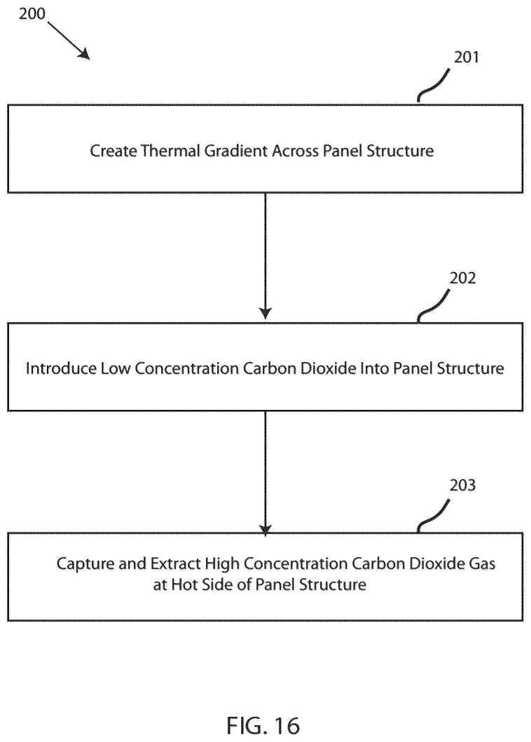

FIG. 16 depicts a flow chart of a method 200 for carbon capture, in accordance with embodiments of the present invention. Step 201 creates a thermal gradient across a panel structure/enclosure, such as panel structure 100. Step 202 introduces low concentration carbon dioxide gas into the panel structure. Step 203 captures and extracts high concentration carbon dioxide gas at a hot side of the panel structure. The low concentration carbon dioxide gas is converted to high concentration gas through diffusion through a porous wicking material soaked with an aqueous amine solution as described supra. In an exemplary embodiment, amine solutions are used but similar action can be achieved with the apparatus using other fluids including but not limited to: carbonate/bicarbonate systems, ionic liquids, and ammonia.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. An apparatus for extracting carbon dioxide, comprising:
a panel structure having a thermal gradient between a first side and a second side; and
a porous wicking material soaked in an aqueous amine solution disposed within the panel structure between the first side and the second side, the porous wicking material configured to absorb a low concentration of carbon dioxide gas at the first side and desorb a high concentration of carbon dioxide gas at the second side.

2. The apparatus of claim 1, wherein the thermal gradient is caused by cooling the first side with ambient air and heating the second side with waste heat.

3. The apparatus of claim 1, wherein the aqueous amine solution reacts with carbon dioxide to form carbamate and/or carbonate according to the following equation: 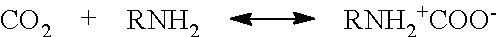
wherein R is a backbone of an amine.

4. The apparatus of claim 1, wherein, as a function of the thermal gradient, the carbon dioxide absorbed by the porous wicking material at the first side reacts with the aqueous amine solution at a low temperature to form carbamate and/or carbonate which diffuses across the porous wicking material to the second side where the carbamate and/or carbonate reacts with the aqueous amine solution at a temperature higher than the first side to form carbon dioxide which is desorbed from the porous wicking material and extracted from the panel structure.

5. The apparatus of claim 1, wherein a concentration of the carbamate and/or carbonate is higher at the first side than at the second side, resulting in a first concentration gradient that causes the carbamate and/or carbonate to diffuse toward the second side.

6. The apparatus of claim 5, wherein a concentration of amine is higher at the second side than at the first side, resulting in a second concentration gradient that causes amines to diffuse toward the first side.

7. The apparatus of claim 1, further comprising:
an inlet for receiving the low concentration of carbon dioxide gas into the panel structure, the inlet disposed proximate the first side of the panel structure; and
an outlet for extracting the high concentration of carbon dioxide gas out of the panel structure.

8. The apparatus of claim 7, further comprising a first plurality of channels disposed within the panel structure proximate the first side, the first plurality of channels being in contact with the porous wicking material and in fluid communication with the inlet and an inlet gas manifold.

9. The apparatus of claim 8, further comprising a second plurality of channels disposed within the panel structure proximate the second side, the second plurality of channels being in contact with the porous wicking material and in fluid communication with the outlet via an outlet gas manifold.

10. The apparatus of claim 9, wherein the low concentration of carbon dioxide gas is introduced within the panel structure through the inlet and flows through the first plurality of channels via the inlet gas manifold to contact the porous wicking material, further wherein a portion of the low concentration of carbon dioxide gas exits the panel structure through an outlet disposed proximate the first side.

11. The apparatus of claim 9, wherein the desorbed high concentration of carbon dioxide gas enters the second plurality of channels and flows through the second plurality of channels to the outlet gas manifold for exiting the panel structure via the outlet.

12. The apparatus of claim 1, wherein the aqueous amine solution is monoethanolamine.

13. The apparatus of claim 1, wherein the first side is metallic panel that includes one or more heat sink elements for cooling the first side.

14. The apparatus of claim 1, wherein the second side is a metallic panels coated with a radiation absorbing material having a high emissivity ratio or in thermal contact with a solar radiation panel.

15. The apparatus of claim 1, further comprising a glass enclosure enclosing the panel structure, and an air gap between the panel structure and a glass layer forming the glass enclosure.

16. An apparatus for extracting carbon dioxide from, comprising:
a panel structure having a first side and a second side that is in thermal contact with a solar radiation panel, wherein solar radiation absorption of the solar radiation panel heats the second side to cause a thermal gradient between the first side and the second side;
an inlet disposed on the panel structure, the inlet configured to receive air having a low concentration of carbon dioxide gas;
a porous wicking material soaked in an aqueous amine solution disposed within the panel structure between the first side and the second side, the porous wicking material configured to absorb the low concentration of carbon dioxide gas at the first side and desorb a high concentration of carbon dioxide gas at the second side; and
an outlet for extracting the high concentration of carbon dioxide gas from the panel structure.

17. The apparatus of claim 16, wherein the panel structure is an integral part of a solar panel device.

18. A method for capturing and concentrating carbon dioxide from a gas, the method comprising:
creating a thermal gradient across a porous wicking material soaked with an aqueous amine solution encased within a panel structure having a cool side and an opposing hot side;
introducing a low concentration carbon dioxide gas to the aqueous amine solution at a cool side of the panel structure; and
capturing and extracting a high concentration of carbon dioxide gas at the hot side of the panel structure.

19. The method of claim 18, wherein the creating the thermal gradient further comprises:
heating the hot side with heat from a solar radiation panel and cooling the cool side with air.

20. The method of claim 18, wherein, as a function of the thermal gradient, the low concentration carbon dioxide gas is absorbed by the porous wicking material at the cool side and reacts with the aqueous amine solution to form carbamate and/or carbonate which diffuses across the porous wicking material to the hot side where the carbamate and/or carbonate reacts with the aqueous amine solution at a temperature higher than the cool side to form carbon dioxide which is desorbed from the porous wicking material and extracted from the panel structure.
